(19) United States
(12) Patent Application Publication
(10) Pub. No.: US 2006/0000592 A1
(43) Pub. Date: Jan. 5, 2006

(54) Device and method for supplying air to the interior of a vehicle

(75) Inventors: Stephane Bosquet, Stuttgart (DE); Laurent Crochemore, Mohnesee (DE); Gebhard Schweizer, Leonberg (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/152,792

(22) Filed: Jun. 15, 2005

(30) Foreign Application Priority Data
Jun. 16, 2004 (DE) 10 2004 028 784.8

(51) Int. Cl. B60H 3/00

(52) U.S. Cl. 165/202; 165/42; 165/43

(57) ABSTRACT

A device (1) for supplying air to the interior (IR) of a vehicle comprises a fan (3) arranged at the flow inlet end for generating a conditioned air stream (IL), and at least one air duct (4a to 4j) in which at least one auxiliary fan (6) is arranged at the flow outlet end.

### CROSS-REFERENCE TO RELATED PATENT APPLICATIONS

The right of priority under 35 U.S.C. §119(a) is claimed based on Federal Republic of Germany Priority Application 10 2004 028 784.8, filed Jun. 16, 2004, the entire disclosure of which, including the specification, drawings, claims and abstract, is incorporated herein by reference.

### BACKGROUND OF THE INVENTION

The invention relates to a device and a method for supplying air to the interior of a vehicle, particularly to the rear area of the vehicle, with a fan for generating an air stream, and with at least one flow channel.

The interiors of land, water or air vehicles are usually heated or air-conditioned by conveying into the vehicle interior air that is suitably conditioned by an air-conditioning system. For this purpose, for example, flow outlets or outflow points are provided at a number of suitable locations and are connected via a flow channel to a heating and/or air-conditioning system. Such a heating and/or air-conditioning system is generally arranged in the forward area of a vehicle, as a result of which it is primarily the front seat passengers who are supplied with conditioned air. For persons sitting in the rear area of the interior, comfort is provided if the delivered air is also passed through additional flow channels into the rear area and only exits at that point. This has an effect on temperature comfort; in particular, unpleasant drafts caused by increased air current velocities inside the interior are reduced, for example, if the passengers have different wishes regarding the degree of desired air-conditioning.

DE 39 40 361 A1 discloses a heating and/or air-conditioning system comprising a heating and/or air-conditioning unit which is arranged in the forward area of the interior. Air distribution channels branch off from this point to air outlet openings, with one air distribution channel comprising at least one air outlet opening and leading into the rear area for ventilation purposes. The air outlet opening can in this case be shut off via a control flap that has its operating elements arranged in the rear area. In addition, a second air duct leads to the rear area. The air ducts can in each case convey heated or cooled air, and both of them open into a mixing area upstream of the air outlet opening.

DE 102 41 460 A1 likewise describes an air-conditioning system having an air-conditioning unit that includes at least one fan, at least one evaporator and at least one heat exchanger. Air channels lead from the unit to air outlets assigned to different zones of a motor vehicle. In this case, separate air channels for cold air and separate air channels for warm air are provided, and these lead in each case from the air-conditioning unit to a control module for each zone. The air quantity and the air temperature can be adjusted for each zone independently.

It is also known to arrange a second air-conditioning unit with separate flow channels in the rear area for supplying conditioned air to the rear area of the interior. However, this entails much higher costs compared to a single air-conditioning unit. In all the known air-conditioning systems and heating systems, one problem is that they take up a great deal of assembly space, because of the required output, and another problem is that they additionally increase the weight of the vehicle.

Additional comfort can also be provided by providing a cold storage box, in which food or other items can be cooled, heated or kept warm. Such a box is known, for example, from DE 198 11 185 C1. It can be closed by a lid and connected to an air channel conveying conditioned air, and it is provided with an air control member which is assigned to an air inlet opening of the cold storage box and which can be adjusted manually to at least two control positions. The air inlet opening is in this case closed automatically when the temperature of air flowing in the air channel (when the box is switched for “Cold air” operation) exceeds a pre-set lower value, or, when the air temperature (in the case where the box is switched for “Warm air”) is below an upper pre-set value. However, this cold storage box has the disadvantage that the air-conditioning system has to deliver the air needed for the respectively desired function of “Cooling” or “Keeping warm” or “Heating”. If the system is adjusted to an unsuitable temperature or is switched off altogether, the cold storage box is ineffective.

### SUMMARY OF THE INVENTION

It is therefore an object of the invention to make available an improved device for supplying air to the interior of a vehicle, which device in particular permits improved temperature comfort in the vehicle and requires less assembly space.

A further object is to make available a particularly suitable method for supplying air to the interior of a vehicle.

In accordance with one aspect of the invention, the has been provided a device for supplying air to the interior of a vehicle, comprising: a first fan arranged at a flow inlet end, for generating a conditioned air stream; and at least one air duct in which at least a second fan is arranged at a flow outlet end.

In accordance with another aspect of the invention, there has been provided a method for supplying air to the interior of a vehicle, comprising: operating a first fan arranged at a flow inlet end for generating a conditioned air stream; conveying a stream of conditioned air through at least one air duct having a remote second end; and compressing the conditioned air stream in said air duct by a second fan arranged at the second end of the air duct.

Further objects, features and advantages of the present invention will become apparent from the detailed description of preferred embodiments that follows, when considered together with the accompanying figures of drawing.

### BRIEF DESCRIPTION OF THE DRAWINGS

In the drawings:

FIG. 1 is a schematic representation of a device for supplying air to the interior of a vehicle, in particular for modular 4-zone air-conditioning of the interior;

FIGS. 2A to 2C are schematic representations of subsidiary channels of a flow channel for warm/cold air, for supplying air to the rear area of the vehicle interior;

FIGS. 3A to 3C are schematic representations of a flow channel designed as a multi-chamber channel with a flexible dividing wall; and

FIGS. 4A and 4B are schematic representations of the principle of a cold storage box connected to a flow channel.

### DETAILED DESCRIPTION OF PREFERRED EMBODIMENTS

In the case of a device which supplies air to the interior of a vehicle, it should take up a small assembly space and also provide better temperature comfort in the rear area. Such a device should be individually controllable with regard to an air stream that is to be conveyed through a flow channel. For this purpose, in addition to a main fan arranged at the flow inlet end of an air-conditioning unit and used for generating an air stream to be conditioned, an additional or auxiliary fan is provided at the flow outlet end in the flow channel.

An auxiliary fan arranged at the outlet end as an auxiliary to the main fan reduces the output requirement of the main fan, as a result of which the main fan can be made smaller. This in turn leads to a lower weight and to a particularly small assembly space.

The auxiliary fan is preferably arranged in the area of a flow outlet which opens into the vehicle interior at the flow outlet end of the flow channel. In this way, the power consumption and the maximum output of the main fan can be particularly easily adapted to one another.

The flow channel is preferably divided into at least two subsidiary channels. This can be accomplished by providing a single channel that is subdivided into plural sub-channels, either by providing one or more dividing walls and/or by providing multiple separate conduits within the flow channel. Alternatively, the flow channel can be produced initially as a multi-chamber channel with several sub-channels, e.g., by extrusion of a multi-channel tube. The term “subsidiary channel” or “sub-channel” refers to either of these preferred configurations. The division into at least two subsidiary channels is preferably achieved by means of a flexible, elastic, foldable and/or displaceable dividing wall. Separate flow channels or sub-channels of a multi-chamber channel, in which warm air and/or cold air is respectively conveyed, permit individual adjustment of a desired air temperature at selected air outlets.

Depending on the nature and design of the device for supplying air, one or more auxiliary fans can be arranged in the flow channel. For example, an auxiliary fan or at least one additional blower wheel (i.e., one fan unit with multiple blower wheels) is respectively connected to each subsidiary channel, thus permitting separate supply of air without mixing of the air streams of the individual channels, and also permitting, at the flow outlet end, targeted adjustment of the respective flow quantity and flow velocity.

A mixing element is preferably arranged upstream and/or downstream of the auxiliary fan. For example, the mixing element can be arranged between the auxiliary fan and the flow outlet. By means of the mixing element arranged between the auxiliary fan and the flow outlet, it is possible to achieve finely metered mixing of cold and warm air, with the subsidiary channels or multi-chamber channels opening into a common flow outlet. With an air supply system of this kind which can be individually controlled, it is possible to obtain a comfortable temperature, especially for passengers sitting in the rear of the vehicle. In particular, the air-conditioning can be improved in the foot-well area. In this case, operation of the auxiliary fan or fans from the rear seats increases comfort, because the passengers in the rear seats no longer depend on the control adjustments performed by the passengers in the front seats. For this purpose, the auxiliary fan is designed such that it can be switched on and/or adjusted, as and when required. The auxiliary fan is able to be switched on or adjusted, in particular, by a person sitting in the rear area. Alternatively, or in addition to this, the auxiliary fan can be switched on or adjusted from a central location, for example, from the driver's seat or from a control unit of the air-conditioning system. Thus, the auxiliary fan allows the air supply to the interior of the vehicle to be adjusted individually in accordance with the flow outlet and in a way that saves energy.

At least one flow control element is preferably arranged in the flow channel. The flow control element is preferably arranged such that it can be moved between a first position that completely opens the flow channel for a warm air stream, and a second position that completely opens the flow channel for a cold air stream. In the case where the flow channel is divided into subsidiary channels, the flow control element can advantageously be moved to an intermediate position for separately conveying a cold air stream and a warm air stream in the flow channel, particularly in respective subsidiary channels. By individually adjusting the cold air stream and/or warm air stream in the flow channel in this way, it is possible, for example, by simultaneously using several subsidiary channels only for cold air or warm air, to convey a maximum cold air stream or warm air stream into the rear area. In this way, it is possible to substantially shorten the time needed to reach a pre-set interior temperature for the rear area. Once the pre-set interior temperature is reached, the flow control element, for example, can be readjusted so that the warm air flows only into the warm air channel (=subsidiary channel) and the cold air flows only into the cold air channel (=subsidiary channel).

A cold storage box is advantageously arranged at the flow outlet end of the flow channel. A cold storage box, which is connected both to a flow channel or to a chamber channel for warm air and also to a flow channel or to a chamber channel for cold air, allows the contents to be conveniently cooled, heated or kept warm, independently of the actual setting of the air-conditioning or heating system.

By means of a dedicated mixing element, the temperature inside the cold storage box can be automatically kept as constant as possible, even when the temperatures of the delivered warm air and cold air change. In this case it is also possible to monitor the air temperatures in order to completely shut off the air delivery if the temperature exceeds or drops below lower and upper temperature limits. This can be done in particular if air of the same temperature is being simultaneously conveyed through the warm air channel and cold air channel in order to accelerate the air delivery for quickly reaching a target temperature.

One particular advantage achieved with the invention is that temperature comfort is improved, in particular for occupants in the rear area of the vehicle. In addition, the device takes up a particularly small assembly space, since the main fan has much smaller dimensions compared to conventional main fans. Multi-zone air-conditioning in the vehicle interior compartment is also possible. Furthermore, a cold storage box can be cooled particularly easily without an additional coolant source. In addition, by heating the cooling box, it can be used as a box for keeping items warm.

Advantageously, at least one or several flow channels in the vehicle, in particular the flow channels leading to the heating or cooling box, are thermally insulated.

Corresponding parts are provided with the same reference labels in all the figures.

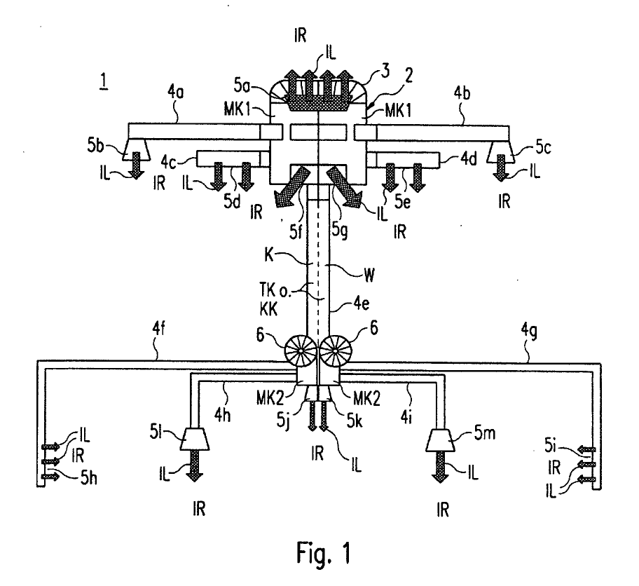

Turning now to the drawings, FIG. 1 shows a device 1 for supplying air to the interior IR of a vehicle, in particular for modular 4-zone air-conditioning. The device 1 comprises an air-conditioning unit 2 with a fan 3 (also called a main fan) arranged at the flow inlet end for delivering fresh air or recirculated air which is conditioned by means of the air-conditioning unit 2. Air ducts 4a to 4i are connected to the air-conditioning unit 2 for the purpose of distributing the conditioned air IL and delivering it to different locations in the interior IR. The air-conditioning unit 2 is situated, as is customary, in the forward area of the vehicle (not shown) and is used to generate both warm air W and also cold air K. The air ducts 4 have a number of flow outlets or vents 5a to 5m which open into the interior IR of the vehicle.

In one exemplary embodiment, the air ducts 4a to 4d for ventilating and heating the forward area of the vehicle are designed as single channels. That is to say, for the forward area, the mixing of the warm air W and the cold air K for the conditioned air IL, which is delivered to the interior IR, takes place inside the air-conditioning unit 2, in particular in a first mixing chamber MK1. In this case, the first mixing chamber MK1 can be designed as one chamber or as several chambers. After mixing in the first mixing chamber MK1, the conditioned air IL is conveyed through the air ducts 4a to 4d and exits through the associated flow outlets 5a to 5g in the forward area, for example, through the flow outlet 5a for “Defrost” mode for defrosting the windows, through the flow outlets 5d, 5e into the forward foot-well, through the flow outlets 5f, 5g into the center of the interior, and through the flow outlets 5b, 5c on the vehicle side into the interior IR.

As an alternative to the air ducts 4a to 4d designed as single channels for the forward area, they can also be designed as multi-channels, i.e., for separate conveying of cold air K and warm air W. In this illustrative embodiment, the conditioned air IL is then generated preferably directly in the area of the flow outlets 5a to 5g, by mixing of the cold air K and the warm air W.

To ventilate and heat the rear area, i.e., the rear seat area in the interior IR, the air duct 4e leads from the air-conditioning unit 2 to the flow outlets 5h to 5m. To achieve the best possible air-conditioning also in the rear area of the interior IR, the air duct 4e is preferably designed with more than one channel in order to separately convey warm air W and cold air K. For example, the air duct 4e is divided into several separate subsidiary channels TK or is designed as a multi-chamber channel comprising several subsidiary channels KK. The air duct 4e runs into the rear area of the vehicle and there has an auxiliary fan 6 at the flow outlet end. Depending on the type and design of the air duct 4e (single channel or multi-channels), it comprises a common auxiliary fan 6, or one individual auxiliary fan per channel TK or KK, or at least one additional blower wheel per channel. In FIG. 1, a two-channel air duct 4e is shown which, at the flow outlet end, has an auxiliary fan 6 for each channel TK or KK, or an auxiliary fan 6 with two blower wheels.

The auxiliary fan 6 is designed as a booster fan. A second mixing chamber MK2 is arranged downstream of the auxiliary fan 6, for example, as a mixing element for mixing the warm air W and the cold air K, which second mixing chamber MK2 can in turn be designed in relation to the number of channels and thus in two parts or as a common mixing chamber MK2 for both channels TK or KK. The air ducts 4f to 4i which open into the flow outlets 5h to 5m are connected to the second mixing chamber(s) MK2. The rear foot-well area is supplied via the flow outlet 5l or 5m, while the flow outlet 5h or 5i provides lateral delivery of air into the interior IR from the center pillar of the vehicle. In addition, the conditioned air IL is guided centrally into the rear interior area IR and thus into the rear area via a flow outlet 5j or 5k, which is arranged at the flow outlet end in the area of the second mixing chamber MK2.

In this example, the auxiliary fan or fans 6 is/are regulated, like the second mixing chamber MK2, by an automatic climate control unit (not illustrated in detail) which can be operated, i.e., switched on or adjusted, by the person(s) sitting in the rear area. Alternately, the controls can also be operated centrally, e.g., by the driver or a front seat occupant, if the rear seat occupants are children or if there are no rear seat occupants at all. Manual adjustment of the auxiliary fan or fans 6 and/or of the second mixing chamber MK2 is also possible.

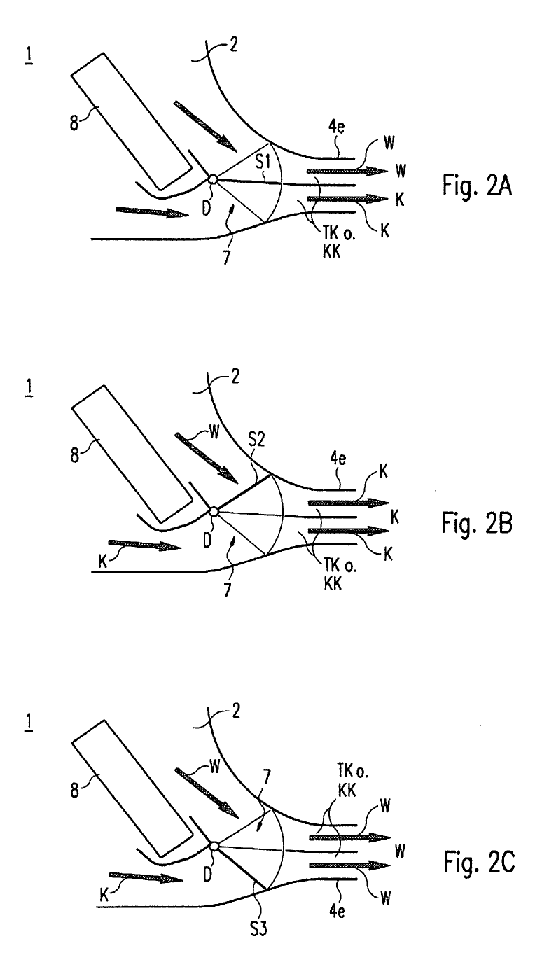

In FIGS. 2A to 2C, a flow control element 7, arranged between the air-conditioning unit 2 and the air duct 4e designed as a two-chamber channel, is shown in three different positions S1 to S3. In FIG. 2A, the flow control element 7 has been moved into the position S1 (=middle position). The flow control element 7 is, for example, a mixer flap or swivel flap which can be swiveled about an axis of rotation D. With the flow control element 7 arranged in the middle position, the air duct 4e is divided into the two channels TK or KK. Cold air K from the air-conditioning unit 2 is conveyed into the one subsidiary channel TK or chamber channel KK, for example the lower one. Warm air W flows from a heater 8 of the air-conditioning unit 2 into the other of the two channels TK or KK, for example, the upper one, of the air duct 4e.

When the device 1 is in operation, different air-conditioning modes, in particular multi-zone air-conditioning, can be set through controlling the air-conditioning unit 2, the flow control element 7, the auxiliary fan 6 and the heater 8. If, for example, the vehicle interior is very hot in high summer, rapid cooling is desired. For this purpose, the flow control element 7 is, as shown in FIG. 2B, moved, i.e., typically, swiveled, into the position S2, so that the flow control element 7 shuts off the supply of warm air W from the air-conditioning unit 2 into the air duct 4e, and, at the same time, only cold air K flows into the air duct 4e and thus into both subsidiary channels TK or KK. Analogously, in winter, for example, rapid heating is desired. For this purpose, the flow control element 7 can be turned to a third position S3, such that the supply of cold air K from the air-conditioning unit 2 is shut off and, at the same time, only warm air W flows into the air duct 4e and all its sub-channels TK or KK. In this way, a maximum flow of warm air per unit of time is achieved.

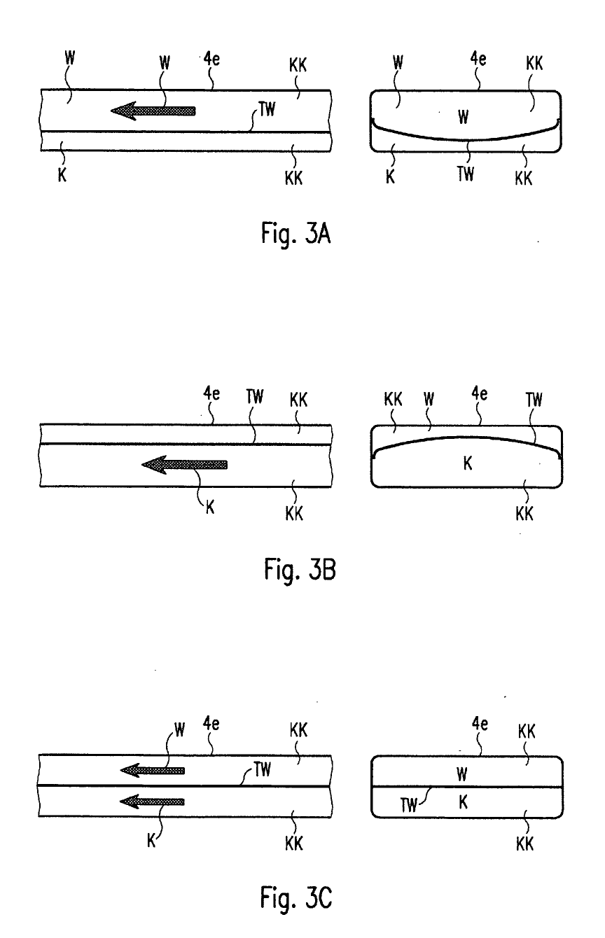

Depending on the embodiment, the air duct 4e is provided with separate subsidiary channels TK or with chamber channels KK. The air duct 4e designed as a multi-chamber channel can in this case be fitted with a flexible, elastic, foldable and/or displaceable dividing wall TW and, in FIGS. 3A to 3C, is shown in each case in longitudinal section and in cross section.

In the case shown in FIG. 3C, the dimensions of the two chamber channels KK are identical when the pressure of the warm air W and cold air K conveyed in each respective chamber channel KK is identical. If the pressure of the warm air W is increased, for example, because there is an increased requirement, the stream of warm air is increased at the flow inlet end and the dividing wall TW, as is shown in FIG. 3A, bulges out, such that the volume of the warm air channel increases, and more warm air W can be transported. Analogously, when the pressure of the cold air K is increased, the volume of the cold air channel concerned increases, as is shown in FIG. 3B.

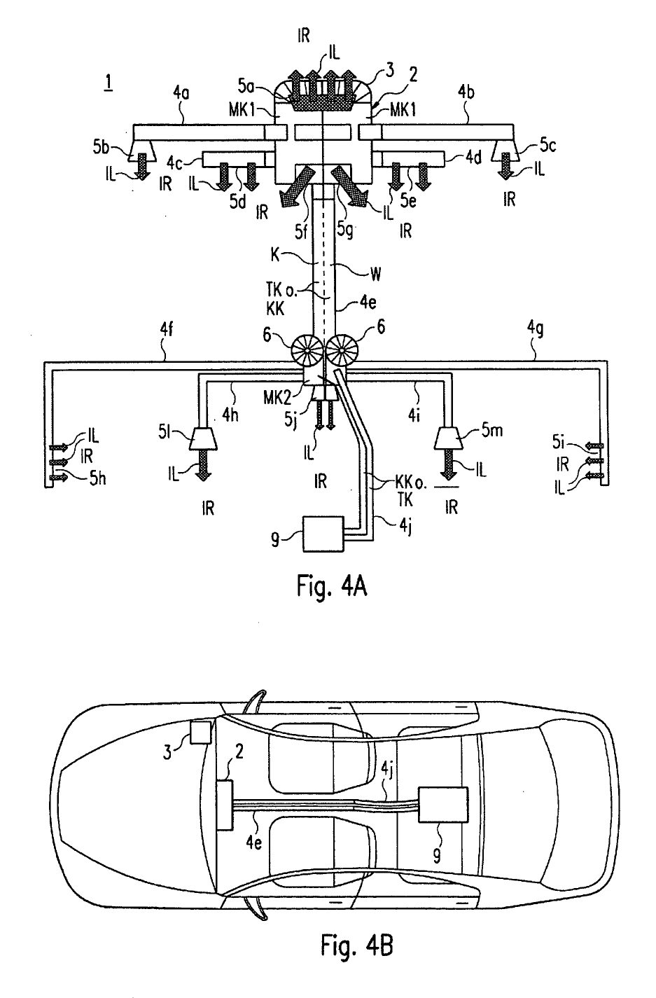

FIG. 4A basically shows the device 1 according to FIG. 1. In addition, a cold storage box 9 is connected to the second mixing chamber MK2, downstream of the auxiliary fan 6, via a further air duct 4j which branches off from the air duct 4e and which is designed as a two-chamber channel. An additional mixing element (not shown) can be arranged at the flow outlet end of the air duct 4j, in the area of the flow inlet of the cold storage box 9. Such an additional mixing element ensures a pre-set temperature by suitable mixing of the warm air W and cold air K conveyed through the relevant channels TK or KK, such that the cold storage box 9 is cooled or heated as desired, with the result that it can be used as a cooling box or as a box for keeping items warm.

If mixing to the pre-set temperature is not possible, the air delivery is shut off. This could be the case, for example, when, in winter, a maximum heating of the interior IR is necessary and, for this purpose, the cold air channel also delivers warm air W, but the cold storage box 9 is set to a cooler temperature. In a particularly simple embodiment, the temperature control of the cold storage box 9 can be set alternately to cooling, heating, or shutting-off of the temperature control, as a result of which the respectively corresponding channel TK or KK of the air duct 4j is opened and the respective other one is shut off, or both are shut off, which can be done using a simple, mechanical three-way valve. FIG. 4B shows the cold storage box 9 in the middle of the rear seat. For temperature control of the cold storage box 9, the latter is connected to the air-conditioning unit 2 via the air ducts 4e and 4j, which are both preferably designed as two-chamber channels.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

What is claimed is:

1. A device for supplying air to the interior of a vehicle, comprising: a first fan arranged at a flow inlet end, for generating a conditioned air stream; and at least one air duct in which at least a second fan is arranged at a flow outlet end.

2. A device as claimed in claim 1, wherein the flow channel opens into at least one flow outlet leading into the vehicle interior, and the second fan is arranged near the flow outlet.

3. A device as claimed in claim 1, wherein the air duct comprises at least two subsidiary channels.

4. A device as claimed in claim 3, wherein the subsidiary channels are separated by a movable dividing wall selected from the group consisting of a deformable wall, a displaceable wall and a combination thereof.

5. A device as claimed in claim 3, wherein each subsidiary channel is provided at its flow outlet end with an associated second fan or at least one additional blower wheel.

6. A device as claimed in claim 1, wherein the air duct comprises as a multi-chamber channel, and each chamber channel comprises at its flow outlet end with an associated second fan or at least one additional blower wheel.

7. A device as claimed in claim 1, further comprising a mixing element, arranged downstream of the second fan.

8. A device as claimed in claim 7, wherein the mixing element comprises a mixing chamber arranged between the second fan and the flow outlet.

9. A device as claimed in claim 1, further comprising a control element for selectively controlling the second fan.

10. A device as claimed in claim 2, wherein the flow outlet opens into a rear area of the vehicle interior.

11. A device as claimed in claim 9, wherein the control element can be operated at least from the rear seat area.

12. A device as claimed in claim 1, further comprising at least one flow control element arranged in the air duct.

13. A device as claimed in claim 12, wherein the flow control element is configured such that it can be moved between a first position that completely opens the air duct for a warm air stream, and a second position that completely opens the air duct for a cold air stream.

14. A device as claimed in claim 13, wherein the flow control element can further be moved to an intermediate position, for separately conveying a cold air stream and a warm air stream in the air duct.

15. A device as claimed in claim 1, further comprising a cold storage box connected to a flow outlet end of the air duct.

16. A device as claimed in claim 15, wherein the cold storage box is connected to a branch air duct branched off from the air duct.

17. A device as claimed in claim 16, wherein the second fan is arranged in the air duct upstream of the branch air duct.

18. A device as claimed in claim 15, further comprising a mixing element arranged at the flow outlet end of the branch air duct.

19. A device as claimed in claim 15, further comprising a control element for selectively supplying the cold storage box with warm and/or cold air, to keep the contents cool and/or hot.

20. A device as claimed in claim 1, wherein at least one air duct is thermally insulated.

21. A method for supplying air to the interior of a vehicle, comprising: operating a first fan arranged at a flow inlet end for generating a conditioned air stream; conveying a stream of conditioned air through at least one air duct having a remote second end; and compressing the conditioned air stream in said air duct by a second fan arranged at the second end of the air duct.

22. A method as claimed in claim 21, wherein the conditioned air stream is compressed directly upstream of a flow outlet of the air duct leading into the vehicle interior.

23. A method as claimed in claim 22, wherein the air stream conveyed through the air duct is a warm air stream and/or a cold air stream.

24. A method as claimed in claim 23, further comprising mixing the warm air stream and the cold air stream in the area of the flow outlet.

25. A method as claimed in claim 21, further comprising conveying a portion of the conditioned air stream from the at least one air duct to a cold storage box via a branch air duct branching from the at least one air duct.
